(19) United States
(12) Patent Application Publication
(10) Pub. No.: US 2008/0099086 A1
(43) Pub. Date: May 1, 2008

(54) Load Sensing Directional Hydraulic Valve

(76) Inventor: Ina Ioana Costin, Lainate (IT)

Correspondence Address: NOTARO AND MICHALOS, 100 DUTCH HILL ROAD, SUITE 110, ORANGEBURG, NY, 10962-2100, US

(21) Appl. No.: 11/718,438

(22) PCT Filed: Nov. 8, 2004
(86) PCT No.: PCT/IT04/00610

§ 371 Date: Jul. 16, 2007

(51) Int. Cl. F15B 13/04

(52) U.S. Cl. 137/596.12

(57) ABSTRACT

A directional hydraulic valve has a feed chamber, two user connection chambers, two discharge chambers connected to a discharge tank, and a control spool. The hydraulic valve also has two intermediate chambers which are connected together, each adjacent the feed chamber and one of the user connection chambers. The intermediate chambers are adapted to be places in fluid communication with a flow regulating device which regulates the flow of fluid originating from the feed source and directed to the feed chamber in relation to the pressure value of the fluid present in the intermediate chambers. The valve has a valve mechanism for connection between the intermediate chambers and one of the discharge chambers.

This invention relates to a directional hydraulic valve according to the precharacterising clause of claim 1.

In particular the hydraulic valve according to this invention may find application in the control of the operation of hydraulic actuators, such as for example hydraulic cylinders and motors.

In its simplest version a directional hydraulic valve comprises a valve body having a feed chamber into which pressurised fluid is fed, two chambers for connection to a user and two chambers for connection to a discharge tank.

The chambers are configured as annular widenings of a longitudinal cavity provided within the valve body and are located adjacent to each other along this cavity. In particular the chambers connecting to the user are located adjacent to the feed chamber on opposite sides, each adjacent to the corresponding discharge chamber.

Within the longitudinal cavity there is slidably housed a control spool comprising a cylindrical body of predetermined diameter and configured with annular members of greater diameter arranged along its axial extension and spaced apart from each other by predetermined intervals as will be more apparent from the remainder of the description Longitudinal sliding of the control spool makes it possible to open/close the passage for fluid between the feed chamber and the chambers connecting to the user. These therefore operate as members opening and/or closing the chambers.

The feed chamber is connected to a tubular inlet connection capable of receiving a hydraulic fluid from a feed source, such as for example a hydraulic pump.

The chambers connecting to the user are connected to corresponding tubular outlet connections capable of being connected alternatively to corresponding delivery and return connections to and from the user which has to be fed.

In the sector of hydraulic actuation the use of directional valves in combination with flow-regulating feedback devices capable of maintaining the flow of fluid fed to the user constant depending on the load felt by the user is known.

For this purpose the directional valve may be provided with a pressure compensator or fed via a variable flow feed source. In the latter case the pressure compensating function is provided directly by the variable flow feed source.

The pressure compensator receives a signal, commonly called Load Sensing or LS, corresponding to the pressure value P_{LS} of the hydraulic fluid “felt” at the user and compares that pressure value P_{LS} with the pressure value of the fluid present in the feed chamber. Depending upon changes in the LS signal, the pressure compensator compensates for the pressure difference created between the feed chamber and the user to maintain the flow of hydraulic fluid between the valve and the user constant. For example, in The situation where the user which has to be controlled is a hydraulic cylinder, the pressure compensator maintains the speed of movement of the hydraulic cylinder piston constant by maintaining the flow of hydraulic fluid to the cylinder constant even as the load perceived by the hydraulic cylinder varies.

Directional hydraulic valves capable of providing an LS signal to a flow regulating system, such as for example a pressure compensator, are called LS directional valves. Various solutions have been proposed for detecting/sampling the LS signal, that is the pressure value P_{L} felt by the user. One well-known solution in the state of the art provides for the use of a control spool which is bored longitudinally and transversely along its axis. The longitudinal hole forms a conduit which places the transverse holes in communication with each other, collecting the LS signal originating from the chamber for connection to the activated user.

The valve body thus has an LS chamber which collect the LS signal from within the control spool.

As a result of communication between the longitudinal conduit and the transverse holes, the LS signal collected in the LS chamber is distributed to the flow regulator device, for example a pressure compensator.

However, this solution has a number of disadvantages from both the manufacturing and functional points of view, particularly with regard to the use of the conduits for collecting the LS signal.

In fact, the typically very small diameter dimensions of the conduits collecting the LS signal make suitable filtering of the hydraulic fluid necessary in order to avoid clogging of the conduits by any impurities present in the fluid.

The abovementioned disadvantages increase when it is necessary to construct a valve of small dimensions with direct electrical activation of the control spool. In this case the stroke of the spool and therefore the dimensions of the LS signal collect holes are further reduced with a consequent increase in the structural complexity of the spool and a greater incidence of filtering problems.

Furthermore, the asymmetrical configuration of the spool, which is due to the asymmetrical structure of the body, has the result that each user connection chamber has a predetermined function. Obviously this imposes a prior choice of the position of the connections to the users which have to be fed, upon the manufacturer and the customer.

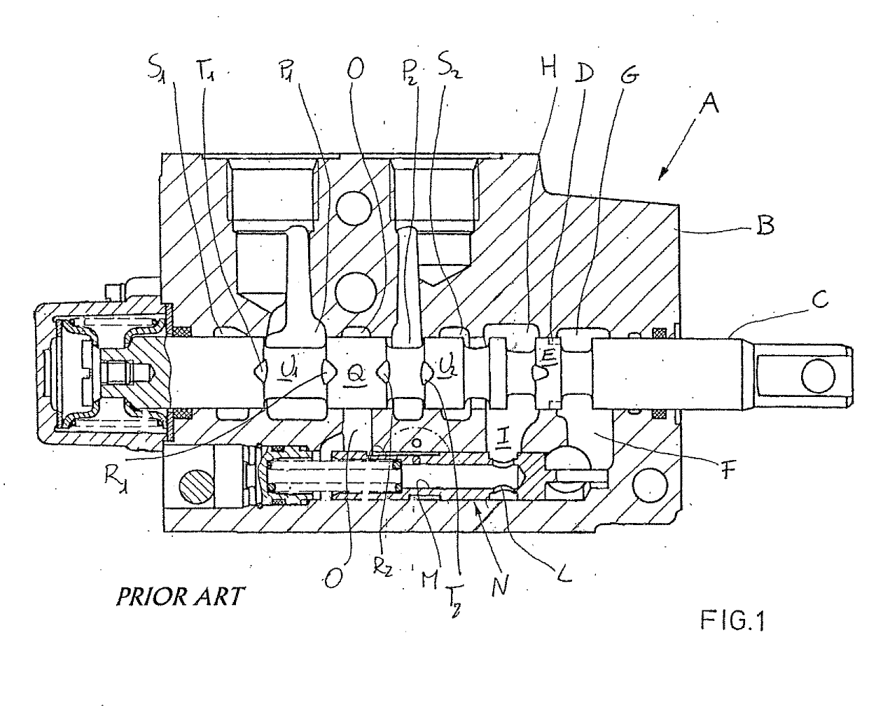

One solution to the abovementioned problems is described in International Patent Application WO03/091576. Appended FIG. 1 illustrates the valve described in aforesaid application WO03/091576. In accordance with the abovementioned known art a valve A comprises a valve body B in which there lies a longitudinal cavity in which a control spool C is slidably mounted.

Through groove D in closure member E the fluid originating from the feed source passes from chamber F to chamber G when the spool is activated, and from there into chamber H and then into channel I. From there the fluid reaches chamber O through radial holes L and the channel M of pressure compensator N. Finally, depending upon the position of spool C, the fluid reaches one of user connection chambers P₁ or P₂ through grooves R₁, R₂ provided in closure member Q. User connection chambers P₁, P₂ can be placed in communication with the adjacent discharge chambers S₁, S₂ through grooves T₁, T₂ in closure members U₁, U₂.

From what has been described above it will be seen that, because it is detected in conduit M, the pressure value sent to the pressure compensator, as reference signal, differs from the pressure value which can be sensed at the user because of the subsequent pressure losses introduced by grooves R₁l, R₂ of closure member Q.

Thus, in accordance with the known art, the pressure signal fed to the compensator device, before arriving at the chambers P₁ and P₂ for distribution to the user, passes through a series of chambers and grooves which, by introducing pressure losses, degrade said signal.

In fact, the pressure signal transmitted to the pressure compensator is substantially different from the pressure signal sensed by the user because of the fact that, between the chamber in which it is sampled and the user connection chambers, it undergoes reductions due not only to the pressure losses introduced by the grooves provided in the spool but also as a result of those brought about by the various passages within the valve body.

Thus LS valves of the known type mentioned above, although overcoming the disadvantages found in valves having spools of small size with axial and radial holes, have appreciable disadvantages because of the losses which are introduced between the point where the LS pressure signal used by the pressure compensator is sampled and the point where the changes in load sensed by the fed user are felt.

Furthermore, the solution proposed in International Patent Application WO03/091576 does not solve the problem of the asymmetry of the components, the body and spools, which determine the prior choice of the positions of the connections to the users which have to be fed.

As a consequence there is a great need to have directional LS hydraulic valves which are capable of collecting an LS signal which corresponds as closely as possible to the pressure value sensed by the user being fed.

The object of this invention is to provide an LS directional hydraulic valve having structural and functional characteristics such as to satisfy the aforesaid requirements and at the same time to overcome the disadvantages mentioned with reference to the known art.

This object is achieved by a hydraulic valve according to claim 1.

Further features and advantages of the hydraulic valve according to this invention will be apparent from the description below of a preferred embodiment thereof, provided by way of indication and without limitation, with reference to the appended figures, in which:

FIG. 1 shows a diagrammatical view of a valve according to the known art,

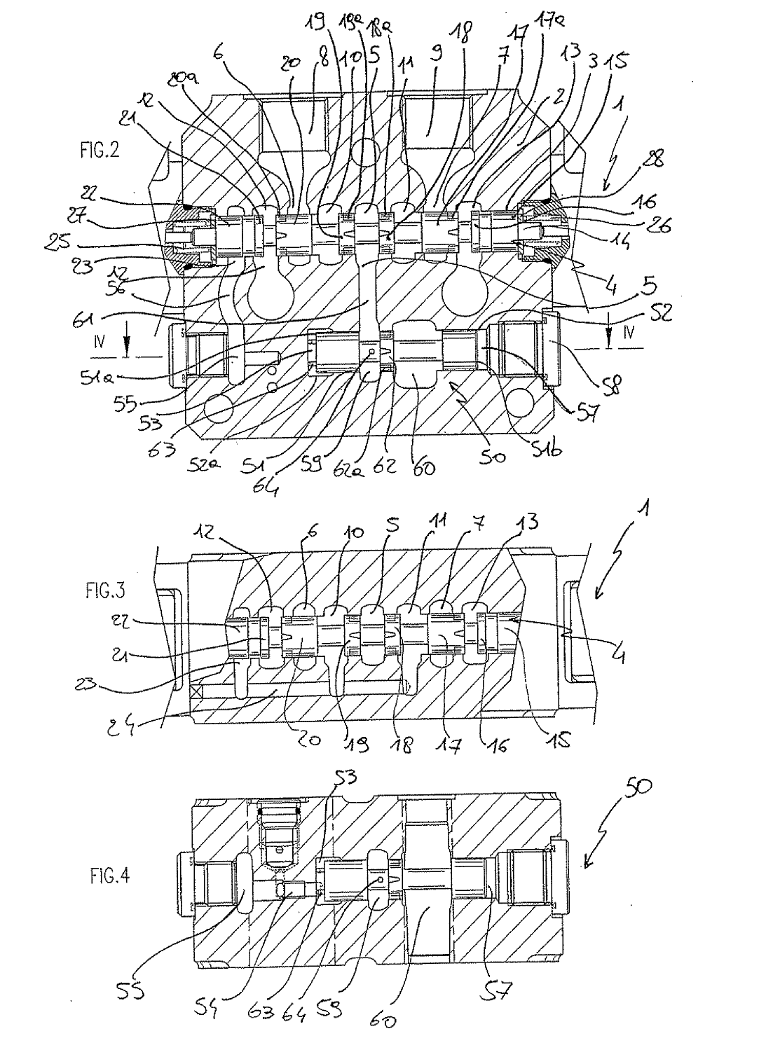

FIG. 2 shows a diagrammatical view in partial longitudinal cross-section of a hydraulic valve according to the invention,

FIG. 3 shows a diagrammatical view in partial cross-section from above of a detail of the valve in FIG. 2,

FIG. 4 shows a diagrammatical view in partial cross-sectional along the line IV-IV in FIG. 2 of a detail of the valve in FIG. 2,

FIGS. 5, 6 and 7 show diagrammatical views of the valve in FIG. 2 in different operating positions, and

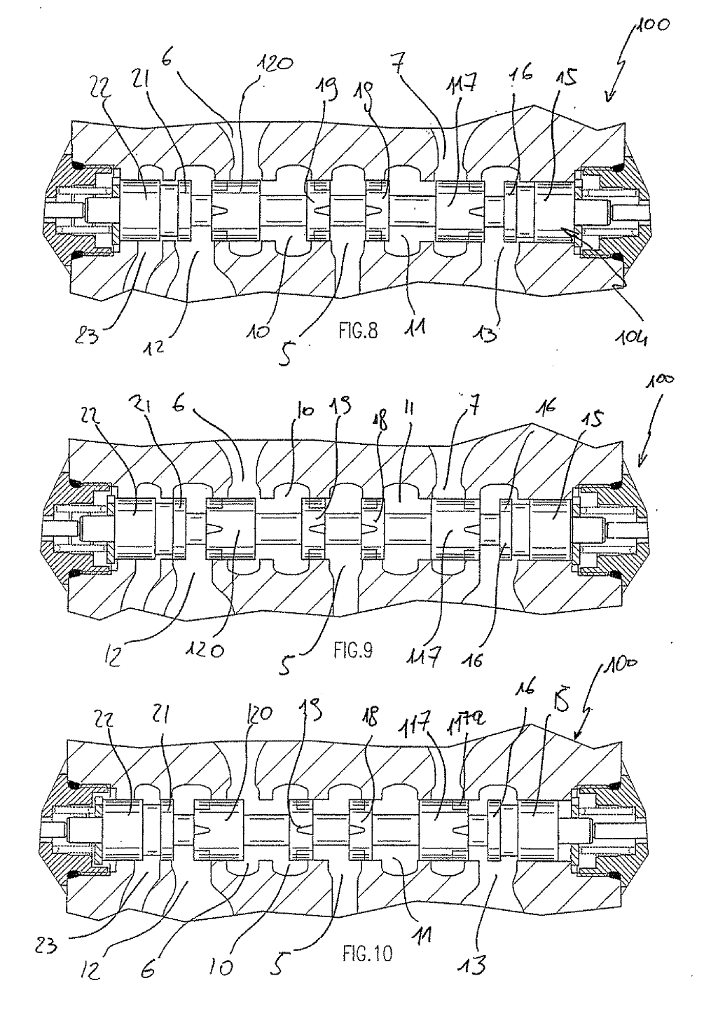

FIGS. 8, 9 and 10 show diagrammatical views of a different embodiment of the valve in FIG. 2 in different operating positions, and

With reference to FIGS. 2 to 10, 1 indicates as a whole a hydraulic valve according to this invention.

Hydraulic valve 1 comprises a valve body 2 having a feed chamber 5 and two chambers 6 and 7 for connection to a user which has to be fed (not illustrated in the figures).

Preferably chambers 5, 6 and 7 are formed as annular widenings of a cylindrical cavity 3 provided within valve body 2 and extend in a mainly longitudinal direction X-X.

Feed chamber 5 is capable of receiving a feeding fluid which is to be fed to the user connection chambers 6 and 7.

User connection chambers 6 and 7 are connected to corresponding outlet connections 8 and 9 which are able of being connected to corresponding connections of the user being fed, for example a hydraulic cylinder (not shown in the figures).

The two user connection chambers 6 and 7 alternatively form a delivery chamber to deliver hydraulic fluid to the user and a recovery chamber to recover hydraulic fluid from the user.

Valve body 2 also comprises two discharge chambers 12 and 13 which are placed in fluid communication with a discharge tank (not shown in the figures).

In order to detect the pressure value P_{LS} of the hydraulic fluid present at the user, valve 1 comprises two intermediate chambers 10 and 11.

Valve 1 also comprises connecting valve means between intermediate chambers 10 and 11 and the discharge tank. In accordance with a preferred embodiment and as illustrated in the figures, intermediate chambers 10 and 11 are connected to each other through a conduit 24.

Valve 1 comprises a lateral chamber 23 connected to intermediate chambers 10 and 11 and located adjacent to one of the two discharge chambers 12, 13, in the example discharge chamber 12.

In accordance with a preferred embodiment and as illustrated in the figures, intermediate chambers 10 and 11 are connected to lateral chamber 23 via conduit 24. Preferably, in the same way as chambers 5, 6 and 7, chambers 10, 11, 12, 13 and 23 are constructed as annular widenings of cylindrical cavity 3 present in valve body 2 extending in a mainly longitudinal direction X-X.

Chambers 5, 6, 7, 10, 11, 12, 13 and 23 are located adjacent to each other along cavity 3.

Intermediate chambers 10 and 11 are located adjacent to feed chamber 5 on opposite sides and each intermediate chamber is located adjacent to a corresponding user connection chamber. In the embodiment illustrated in the figures, intermediate chamber 10 is located adjacent to user connection chamber 6, while intermediate chamber 11 is located adjacent to user connection chamber 7.

Each discharge chamber is located adjacent to a corresponding user connection chamber. In the embodiment illustrated in the figures discharge chamber 12 is located adjacent to user connection chamber 6, while discharge chamber 13 is located adjacent to user connection chamber 7.

Valve 1 also comprises a control spool 4 which is slidably housed within longitudinal cavity 3.

Control spool 4 comprises a spool body 14 and a plurality of closure members 15, 16, 17, 18, 19, 20, 21 and 22 located along the body of closure 14 at predetermined intervals. Preferably closure members 15, 16, 17, 18, 19, 20, 21 and 22 of spool 4 are annular members of greater diameter than the diameter of the cylindrical body of spool 4.

In particular, closure members 17, 18, 19, 20, 21 and 22 are positioned in such a way that longitudinal movement of control spool 4 makes it possible to open/close the passage of fluid between chambers 5, 6, 7, 10, 11, 12, 13 and 23.

In particular, closure members 18 and 19 are capable of opening/closing the passage of hydraulic fluid between feed chamber 5 and intermediate chamber 11 and between feed chamber 5 and intermediate chamber 10 respectively.

Closure members 20 and 17 are capable of opening/closing the passage of hydraulic fluid between user connection chamber 6 and discharge chamber 12 and intermediate chamber 10, and between user connection chamber 7 and discharge chamber 13 and intermediate chamber 11 respectively.

Closure members 21, 22 are capable of opening/closing the passage of hydraulic fluid between lateral chamber 23 and discharge chamber 12, that is between lateral chamber 23 and the discharge tank. Closure members 21, 22 therefore act as valve means for connecting the intermediate chambers 10 and 11, connected to lateral chamber 23, and the discharge tank.

Closure members 15 and 22 are used to isolate chambers 13 and 23 from the outside of the valve body 2.

Closure member 16 makes control spool 4 symmetrical. In this way, mere inversion of the direction in which spool 4 is inserted into cavity 3 makes it possible to change the feed ratios, that is the passage areas for the fluid in the two user connection chambers, thus avoiding prior choice of the connections by the valve user.

Preferably closure members 17, 18, 19 and 20 each have a plurality of corresponding longitudinal grooves 17a, 18a, 19a and 20a.

Each group of grooves extends longitudinally in such a way as to open a passage between two adjacent chambers following axial displacement of the closure member itself or control spool 4.

In the embodiment illustrated in the figures, grooves 19a and 18a are configured in such a way as to open a passage between feed chamber 5 and intermediate chambers 10 and 11 respectively.

Alternatively, the passage between feed chamber 5 and intermediate chambers 10 and 11 respectively may be opened in on-off mode through the movement of control spool 4, that is closure members 18 and 19.

Grooves 17a and 20a are configured in such a way as to open a passage between discharge chamber 13 and user connection chamber 7 and between discharge chamber 12 and user connection chamber 6 respectively.

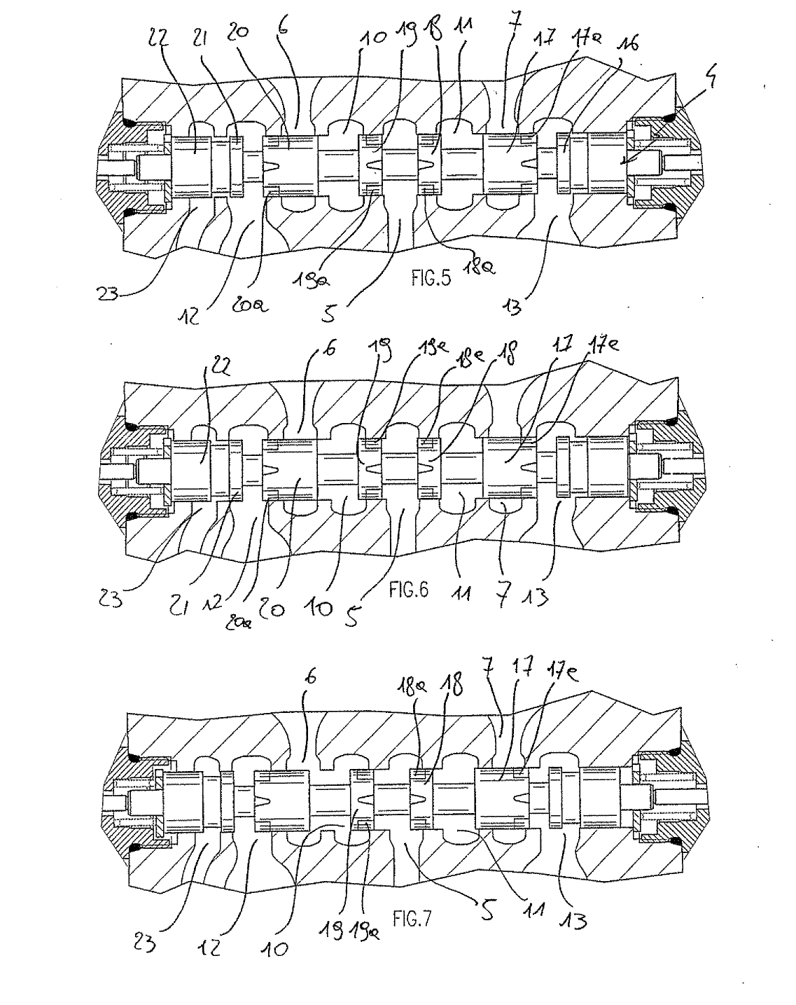

Control spool 4 is movable for sliding along longitudinal direction X-X between a resting position (FIG. 5) and an operating position (FIG. 7).

In the embodiment illustrated in the figures, the control spool is activated directly through a proportional coil electromagnet. Alternatively control spool 4 may be activated by electromagnetic, hydraulic and manual activating means.

The embodiment illustrated in FIGS. 5 to 7 shows a control spool 4 of the closed centre type. With this type of spool, when the spool is in the resting position, user connection chambers 6 and 7 are isolated from the corresponding adjacent discharge chambers 12 and 13.

In the resting position feed chamber 5 is isolated from user connection chambers 6 and 7. Closure members 17, 18, 19 and 20, which prevent the fluid present in feed chamber 5 from flowing into adjacent intermediate chambers 10 and 11 and therefore from flowing into user connection chambers 6 and 7 are used for this purpose.

Conversely, in the operating position, feed chamber 5 is in fluid communication with one of the two user connection chambers 6, 7 through corresponding intermediate chambers 10, 11.

When spool 4 moves in such a way that groove 19a of closure member 19 opens a passage between feed chamber 5 and intermediate chamber 10, closure member 18 is in a position in which it maintains feed chamber 5 isolated from intermediate chamber 11.

Due to the fact that they are positioned between feed chamber 5 and the corresponding user connection chambers 6 and 7, intermediate chambers 10 and 11 make it possible to determine the pressure value P_{LS} of the hydraulic fluid sensed at the user. Substantially, intermediate chambers 10 and 11 represent an extension of user connection chambers 6 and 7 so that the pressure value P_{LS} of the fluid corresponds to the actual pressure value sensed by the user.

This pressure value P_{L} must be provided as an input to a flow regulating device capable of regulating the flow of hydraulic fluid fed from the hydraulic feed source to feed chamber 5, and therefore to user connection chambers 6 and 7, depending on the changes in the pressure of hydraulic fluid “felt” at the user so as to maintain constant the flow of fluid fed to the user via valve 1.

When control spool 4 is in the resting position, valve means 21, 22 place intermediate chambers 10 and 11 in fluid communication with the discharge tank and therefore intermediate chambers 10 and 11 are discharged. Because intermediate chambers 10 and 11 are connected to lateral chamber 23 via conduit 24, valve means 21, 22 place chamber 23 in fluid communication with the discharge tank.

When control spool 4 is in the operating position, valve means 21, 22 prevent fluid communication between intermediate chambers 10 and 11 and the discharge tank Thus when control spool 4 is in the operating position, intermediate chambers 10 and 11, and therefore lateral chamber 23, are isolated from the discharge tank.

As will be better described below, in the operating position control spool 4 places feed chamber 5 in fluid communication with one of adjacent intermediate chambers 10, 11, chamber 10 in the example, and intermediate chamber 10 with the adjacent user connection chamber 6, while the other user connection chamber 7 is placed in fluid communication with the discharge tank via discharge chamber 13.

In accordance with the embodiment illustrated in the figures, the flow regulator device is a pressure compensator 50 comprising a pressure regulating spool 51 slidably housed in a longitudinal cavity 52 within valve body 2 parallel to longitudinal cylindrical cavity 3.

At one extremity 52a of cavity 52 there is a chamber 53 for receiving the pressure signal, which is connected to intermediate chambers 10 and 11, and at the opposite extremity 52b of cavity 52 there is a chamber 57 for receiving the feed signal, which is closed off from the exterior through a cap 58.

Preferably, conduit 24, which is connected to lateral chamber 23, is connected to a conduit 56 which ends in a chamber 55. Finally, chamber 55 is connected to a conduit 54 which carries the fluid into chamber 53 of pressure regulator 50.

Thus the pressure value P_{LS} of the hydraulic fluid present in intermediate chambers 10 and 11 is delivered to pressure signal receiving chamber 53. In chamber 53 the fluid imparts a force of pressure F_{LS} on the base surface 51a of regulating spool 51.

A chamber 59 connected to feed chamber 5 through conduit 61 and a chamber 60 which is capable of being fed by the hydraulic feed source are located along cavity 52. Preferably chambers 59 and 60 are constructed as annular widenings of cylindrical cavity 52.

Chamber 60 is adjacent to chamber 59 and is separated therefrom by a closure member 62 of regulating spool 51.

Chamber 60 receives hydraulic fluid fed from the hydraulic feed source and through longitudinal grooves 62a provided within closure member 62 of regulating spool 30 transmits the hydraulic fluid to adjacent chamber 59. Grooves 62a extend longitudinally in such a way as to open a passage between chamber 60 and chamber 59 following axial movement of regulating spool 51.

Resilient means 63 acting on base surface 51a of regulating spool 51 with a predetermined elastic load F_{S} are housed within chamber 53 in such a way as to hold regulating spool 51 in a position such that chamber 60 is isolated from chamber 59 in the absence of any feed from the hydraulic feed source.

At chamber 59, regulating spool 51 also has a transverse hole 64 connected to a longitudinal conduit (not shown in the figures) provided internally within regulating spool 51. This longitudinal conduit terminates in chamber 57 which is bounded by cap 58 on one side and by the extremity 51b of regulating spool 51, opposite to extremity 51a on which resilient means 63 act, on the other side.

Therefore, when the feed source feeds chamber 60 and spool 51 is in a position such as to place chambers 59 and 60 in communication, the pressure F_{P} of the fluid present in feed chamber 5 is delivered to chamber 57 through hole 64.

Wit chamber 57 this pressure produces a force F_{P} which acts on extremity 51b of spool 51 opposing the force F_{S} of resilient means 64 acting on the opposite end 51a of spool 51 and the pressure force F_{LS} sensed by the user.

Alternatively, the flow regulating device may be constructed differently, or may be provided externally to the valve, or a feed source with a variable flow which is itself operated by the pressure regulating device may be provided. In any event a connection has to be provided between intermediate chambers 10 and 11 and the LS input to the flow regulating device.

The flow regulator is capable of receiving an LS signal corresponding to the pressure value P_{LS} of the hydraulic fluid “sensed” at the user and of comparing that pressure value P_{LS} with the value of the pressure present in feed chamber 5. Depending on the changes of signal LS, the flow regulator compensates the pressure difference which is generated between feed chamber 5 and the user, that is between feed chamber 5 and the intermediate chamber adjacent to the chamber for connection to the activated user. In this way the flow regulating device maintains the flow of hydraulic fluid fed to the user constant.

The LS signal may be delivered to the flow regulator in different ways.

In accordance with the embodiment illustrated in the figures, intermediate chambers 10 and 11 are connected to the LS input of pressure compensator 50, represented by chamber 53. Alternatively, the pressure value P_{LS} of the fluid present in intermediate chambers 10 and 11 may be detected by a pressure transducer and converted into an equivalent electrical signal which can be used by a flow regulator. For example, in the case of pressure compensator 50, this electrical signal may be used to control the movement of regulating spool 51.

The operation of valve 1 will now be described from a starting position in which control spool 4 is in the resting position (FIG. 5).

Control spool 4 is held in the resting position as the result of the action of opposing resilient means 25, 26 acting with an equal and opposite resilient loading on corresponding opposing flanges 27, 28 provided on closure members 22 and 15 of spool 4.

When spool 4 is in the resting position, closure members 18 and 19 are in a position such as to isolate feed chamber 5 from intermediate chambers 10 and 11, and closure members 17 and 20 are in a position such as to isolate intermediate chambers 10 and 11 from user connection chambers 6 and 7. Thus when spool 4 is in the resting position feed chamber 5 is isolated from user connection chambers 6 and 7.

Furthermore, with spool 4 in the resting position, closure member 21 is in a position such as to open a passage between discharge chamber 12 and adjacent lateral chamber 23. Because lateral chamber 23 is connected to intermediate chambers 10 and 11 through conduit 24, intermediate chambers 10 and 11 discharge to the discharge tank.

When the feed source feeding the chamber 60 is activated, pressure P_{P} of the fluid present in the feed chamber 5 is delivered to chamber 57 through conduit 61 and hole 64. Pressure P_{P} sets up a force F_{P} which acts on surface 51b of spool 51 opposing force F_{S} of the spring and F_{LS} from the intermediate chambers, so as to move spool 51 into an equilibrium position.

In order to feed the user it is necessary to place feed chamber 5 in fluid communication with one of the user connection chambers and discharge the other user connection chamber. In the example described below, control spool 4 moves to place feed chamber 5 in fluid communication with user connection chamber 6, and user connection chamber 7 in fluid communication with discharge chamber 13. For this purpose control spool 4 is activated as shown in FIGS. 4 and 5, moving longitudinally until groove 19a in closure member 19 opens a passage between feed chamber 5 and intermediate chamber 10. When it is necessary to feed the user connection chamber 7 and discharge the user connection chamber 6, the control spool 4 moves in the opposite direction to place feed chamber 5 in fluid communication with user connection chamber 7 and the user connection chamber 6 in fluid communication with discharge chamber 12.

As shown in the figures, during a first portion of the stroke of control spool 4, closure member 21 progressively closes the connection between discharge chamber 12 and lateral chamber 23, that is the fluid connection between the discharge tank and intermediate chambers 10 and 11.

Total closure of the connection or lateral chamber 23 and discharge chamber 12 corresponds with the start of opening of a passage between feed chamber 5 and intermediate chamber 10.

At the same time, closure member 20 opens the connection between intermediate chamber 10 and user connection chamber 6, and groove 17a in closure member 17 opens a passage between user connection chamber 7 and discharge chamber 13. Intermediate chamber 11 instead remains isolated from adjacent feed chamber 5 and user connection chamber 7.

When control spool 4 completes its stroke, feed chamber 5 is in fluid communication with intermediate chamber 10 through the passage opened by groove 19a of closure member 19, and intermediate chamber 10 is connected to user connection chamber 6. In this situation the fluid originating from the feed source passes through intermediate chamber 10 from feed chamber 5 to user connection chamber 6 and is then fed to the user, for example a hydraulic cylinder. The fluid originating from the hydraulic cylinder is collected from the user connection chamber 7 which is connected, via discharge chamber 13, to the discharge tank.

Up till the value of the load sensed by the user, that is the value of the pressure of the fluid present in the piston of the hydraulic cylinder, is constant, the piston moves at a constant velocity determined by the same load and the fluid pressure fed. As the load sensed by the user, that is the forces acting on the piston against and with its sliding movement, vary, and in the absence of a feedback system, the velocity of the piston will correspondingly decrease or increase.

The value of the pressure of the fluid present within user connection chamber 6 is transmitted via intermediate chamber 10 to the pressure compensator on the side adapted to receive the LS signal.

When control spool 4 is in the operating position, user connection chamber 6 is in fluid communication with intermediate chamber 10. Thus the pressure value of the fluid present in user connection chamber 6 is the same as the pressure value P_{LS} present in intermediate chamber 10. In other words, intermediate chamber 10 becomes a sort of extension of the user connection chamber which senses the user pressure.

It should be noted that, when spool 4 is in the working position (FIG. 7), the opening between intermediate chamber 10 and user connection chamber 6 is greater than the opening between feed chamber 5 and intermediate chamber 10. In this way the pressure value P_{LS} of the fluid present in intermediate chamber 10, delivered to chamber 53 of regulating spool 51, corresponds to the pressure value “sensed” by the user being fed. Therefore any change in the pressure at the user is “sensed” in the intermediate chamber 10 and delivered to pressure compensator 50 without introducing any losses.

In the light of what has been stated above it will be seen that the valve according to the invention makes it possible to detect the LS signal, that is the pressure value felt by the user without introducing any losses in the path of recovering the LS signal.

A further advantage of valve 1 according to the invention lies in the fact that because of the symmetry of the members forming spool 4 it is sufficient to reverse the direction of assembly of spool 4 to make the allocation of the user connections indifferent.

The embodiment described above and illustrated in FIGS. 5 to 7 may be used for user, such as for example hydraulic cylinders, which need to have the user isolated from the discharge tank when the control spool is in the resting position.

In the case where the user which has to be fed is for example a hydraulic motor, user connection chambers 6 and 7 must be connected to discharge chambers 12 and 13 when spool 4 is in the resting position. Spools of the abovementioned type are commonly known as open centre spools.

In order to ensure that the users are connected to the discharge tank, when the spool is in the resting position, the solutions in most common use provide for an increase in the longitudinal length of the grooves located between the user connection chambers and the adjacent discharge chambers.

With reference to FIGS. 8 to 10, 100 indicates as a whole a valve according to an alternative embodiment of this invention. The parts of valve 100 which are structurally and functionally equivalent to valve 1 are identified by the same reference numbers and will not be further described.

In accordance with this embodiment, when control spool 104 is in the resting position (FIG. 8), closure members 117 and 120 make it possible to place intermediate chambers 10 and 11 in fluid communication with the corresponding adjacent user connection chambers 6 and 7.

As a consequence, because intermediate chambers 10 and 11 are connected to lateral chamber 23 via conduit 24 and from there with discharge chambers 12 and 13, the user is discharged via discharge chambers 12 and 13 when spool 4 is in the resting position.

As will be appreciated from what has been described, the hydraulic valve according to this invention makes it possible to satisfy the requirements and overcome the disadvantages mentioned in the introductory part of this description in comparison with the known art.

The valve according to the invention provides a solution which simplifies construction of the control spool eliminating the internal holes for collecting and transmitting the LS signal to the pressure compensator, thus overcoming the problem of filtration of the hydraulic fluid feed.

Furthermore, the pressure signal LS which is delivered to the pressure compensator has the same value as the signal “felt” by the user being fed, as the intermediate chambers, from which the LS signal is recovered, are adjacent to the user connection chambers and can be placed in fluid communication merely through movement of the control spool.

Advantageously, the area of the passage opened by the control spool between the user connection chambers and the adjacent intermediate chambers is greater than the area of the passage opened by the control spool between the feed chamber and the adjacent intermediate chambers.

Also, use of the valve according to this invention makes it possible to contain the axial fluid dynamic forces which are generated when the user connection chambers are connected to the discharge chambers when the spool is centre open type. Furthermore, the symmetrical position of the intermediate chambers makes it possible to have a symmetrical spool which does not impose a prior choice of connections to the user being fed upon either the manufacturer or the customer.

Obviously persons skilled in the art may make many modifications and variants to the hydraulic valve according to the invention described above in order to satisfy contingent and specific requirements, but all these shall nevertheless be contained within the scope of the protection of the invention as defined by the following claims.

1. Directional hydraulic valve (1) for feeding a user, comprising:
a valve body (2) having a cylindrical cavity (3) extending in a longitudinal direction (X-X),
a feed chamber (5) provided in the said cavity (3) and capable of receiving a pressurised fluid from a feed source,
a first (6) and a second (7) user connection chamber, provided in the said cavity (3) and adapted to be connected to corresponding connections of the user which is to be fed,
a first (12) and a second (13) discharge chamber provided in the said cavity (3) and connected to a discharge tank, each discharge chamber being located adjacent to one of the said user connection chambers (6, 7),
a control spool (4) slidably mounted along the said longitudinal direction (X-X) in the said cavity (3),
characterised in that it includes:
a first intermediate chamber (10) and a second intermediate chamber (11) provided in the said cavity (3) and connected to each other, each intermediate chamber being located adjacent to the feed chamber (5) and to one of the said user connection chambers (6, 7), the said first intermediate chamber (10) and second intermediate chamber (11) being adapted to be placed in fluid communication with a flow regulating device (50), the said regulating device (50) regulating the flow of fluid originating from the feed source and directed to the said feed chamber (5) depending on the value of the fluid pressure present in the said intermediate chambers (10, 11), and
valve means (21, 22) providing connection between the said intermediate chambers (10, 11) and one of the said discharge chambers (12, 13), the said control spool (4) moving between a resting position in which the said valve means (21, 22) place the said intermediate chambers (10, 11) in fluid communication with the said one discharge chamber, and an operating position in which the said valve means (21, 22) prevent fluid communication between the said intermediate chambers (10, 11) and the said one discharge chamber, in the said operating position the said control spool (4) placing the said feed chamber (5) in fluid communication with one of the adjacent intermediate chambers (10, 11) and the said one of the adjacent intermediate chambers (10, 11) with the adjacent user connection chamber, the other user connection chamber being placed in fluid communication with the other discharge chamber.

2. Directional hydraulic valve (1) according to claim 1, in which the said control spool (4) comprises distinct annular closure members (17, 18, 19, 20) capable of opening/closing a passage for the passage of fluid between the said feed chamber (5) and the adjacent intermediate chambers (10, 11), and between the intermediate chambers (10, 11) and the adjacent user connection chambers (6, 7), the longitudinal movement of the said control spool (4) bringing about opening/closure of the said passages for the passage of fluid.

3. Directional hydraulic valve (1) according to claim 2, in which when a first passage opens for the passage of fluid between the said feed chamber (5) and an adjacent intermediate chamber (10) a second passage opens between the said an adjacent intermediate chamber (10) and the adjacent user connection chamber (6).

4. Directional hydraulic valve (1) according to claim 3, in which the area for the passage of fluid through the said second passage is greater than the area for the passage of fluid through the said first passage.

5. Directional hydraulic valve (1) according to claim 2, in which the annular closure members (18, 19) capable of opening/closing a passage between the feed chamber (5) and the adjacent intermediate chambers (10, 11) comprise corresponding grooves (18a, 19a) extending longitudinally in such a way as to open a passage between the adjacent chambers following axial movement of the control spool (4).

6. Directional hydraulic valve (1) according to claim 5, comprising a lateral chamber (23) provided in the said cavity (3) and located adjacent to the said one discharge chamber (12), the said lateral chamber (23) being connected to the said intermediate chambers (10, 11), the said valve means (21, 22) comprising an annular closure member (21) capable of opening/closing the passage of fluid between the said lateral chamber (23) and the one said discharge chamber (12).
